(19) United States
(12) Patent Application Publication
(10) Pub. No.: US 2025/0328385 A1
(43) Pub. Date: Oct. 23, 2025

(54) COMPUTING SYSTEM WITH ENERGY AWARENESS

(71) Applicant: Hewlett Packard Enterprise Development LP, Spring, TX (US)

(72) Inventors: Sai Rahul Chalamalasetti, Milpitas, CA (US); Aditya Dhakal, Milpitas, CA (US); Alok Mishra, Berkeley Heights, NJ (US); Gourav Rattihalli, Milpitas, CA (US); Dejan S. Milojicic, Milpitas, CA (US)

(21) Appl. No.: 18/639,342

(22) Filed: Apr. 18, 2024

(51) Int. Cl. G06F 9/50; G06F 8/41

(52) U.S. Cl. CPC G06F 9/5027; G06F 8/41

(57) ABSTRACT

In an example implementation, a computer-implemented method includes determining resources available to execute a job and determining a location of each resource and a connected topology of the resources. For each of a combination of the available resources, bandwidth information related to channels to move data to the resources to execute the job is determined. The bandwidth information considers the location of data to be used to execute the job and the channels between the resources. The job is assigned to a resource or a combination of resources using a scheduling algorithm that takes into account the bandwidth information and power considerations.

### BACKGROUND

A cloud service can encompass a distributed computing framework designed for the efficient execution of tasks across multiple computer and storage nodes. At the core of this service, a workflow manager orchestrates the flow of jobs, ensuring that task dependencies are respected and that jobs proceed in the correct sequence. Upon receiving a job submission, the workflow manager determines the optimal execution path by analyzing the requirements of the job and the current state of the system. A scheduler interacts closely with the workflow manager, responsible for allocating resources and assigning jobs to specific nodes based on availability, capability, and performance metrics. The scheduler employs an algorithmic approach that considers factors such as load balancing, resource utilization, and priority to determine the best node for execution, thereby aiming to maximize efficiency and minimize job completion time.

### BRIEF DESCRIPTION OF THE DRAWINGS

Aspects of the present disclosure are best understood from the following detailed description when read with the accompanying figures.

FIG. 1A illustrates a computer system with various interconnected components and hierarchies, as an example implementation.

FIG. 1B illustrates an example implementation of the computer system of FIG. 1A.

FIGS. 2A-2B depict the partitioning of a workflow across different resources, according to an example implementation.

FIG. 3A shows a block diagram of a computing system processing code with a just-in-time compiler, as an example implementation.

FIG. 3B provides a specific example of the system depicted in FIG. 3A.

FIG. 4 presents a system for managing and compiling workloads across multiple nodes, according to an example implementation.

FIG. 5 illustrates an implementation example of a computer device 500, according to an example implementation.

Corresponding numerals and symbols in the different figures generally refer to corresponding parts unless otherwise indicated.

### DETAILED DESCRIPTION

The present disclosure describes a cloud service that employs an advanced workflow manager and scheduler to efficiently execute jobs across a multitude of compute and storage nodes. This service is designed to optimize energy or power consumption by intelligently assigning tasks to the appropriate resources based on a variety of factors, including the type and location of the resources, the topology of the interconnected system, and the bandwidth information of the channels used to transfer data. The workflow manager orchestrates the distribution of workloads, while the scheduler dynamically computes the hardware placement of these workloads. By leveraging a cost function that accounts for data movement, power considerations, and computation time, the system ensures that jobs are executed in the manner that minimizes energy usage while maintaining high performance.

The cloud service's scheduler is capable of handling complex decision-making processes that involve evaluating the available types of processors and accelerators, the volume of data to be processed, and the current system utilization. It can utilize just-in-time compilation techniques to adapt to changing conditions and optimize the execution of bytecode at runtime. This approach allows for a flexible and adaptive system that can respond to varying workloads and infrastructure states, ensuring that the cloud service operates with the utmost energy efficiency without compromising on the quality of service or execution speed.

Sustainability has become an essential consideration in the realm of computing systems, especially as processing data advances to the scale of zettabytes. To optimize energy efficiency, the scheduling of workloads should be managed to minimize power usage. Historically, prior research and development in schedulers—which encompass workflow managers and workload schedulers—have primarily focused on computation while generally overlooking the significance of data movement.

The energy consumed for data communication outside a chip exceeds that used for a 64-bit floating-point operation. The hierarchy of energy consumption in computational processes illustrates that energy expended on floating-point computation is less than that required for data movement inside the chip, which in turn is less than the energy needed for data movement outside the chip. This relationship can be taken into account when making decisions regarding scheduler designs.

With the rise of emerging workloads such as machine learning (ML) training, which work with vast volumes of data, there is an associated increase in data movement. These activities can result in substantial energy demand. With this in mind, examples disclosed herein implement data-movement aware scheduling to reduce energy consumption. Acknowledging and incorporating this strategy into scheduler mechanisms can contribute significantly to promoting energy savings in computing environments.

To mitigate the energy consumption associated with data movement in computing systems, a variety of strategies can be adopted, either individually or synergistically. One approach involves minimizing the data movement across chips or nodes. This can be achieved by associating a communication cost function with the directed acyclic graph (DAG) components, which reflect the static dependencies intrinsic to the workflow manager. By quantifying communication costs within the scheduling process, the system can make more informed decisions that favor energy efficiency.

Another strategy is to organize tasks into subsets based on data-dependency and to schedule these subsets on the most energy-efficient computational resources. This means packing tasks that are interconnected within the workflow closer together to reduce data transfers. The prioritization is to schedule these subsets on a single chip first, if possible, or otherwise on a single node before considering multiple nodes. By making initial scheduler decisions dynamically, the scheduler can place tasks in a way that reduces unnecessary data movement.

Additionally, employing just-in-time (JIT) compilation as part of the scheduling process offers the flexibility to dynamically map task subsets to the appropriate hardware resources based on current system conditions and workload demands. The JIT scheduler can adjust previous scheduling decisions in real-time, allocating tasks to minimize energy-intensive data movement as workflows evolve. Implementing JIT compilation in scheduling mechanisms ensures that a system can respond adaptively to fluctuating workloads and system states, thereby assisting in further energy savings by optimizing data movement.

The following disclosure provides many different examples for implementing different features. Specific examples of components and arrangements are described below to simplify the present disclosure. These are, of course, merely examples and are not intended to be limiting. It is understood that features of the various examples can be combined, even when not explicitly shown.

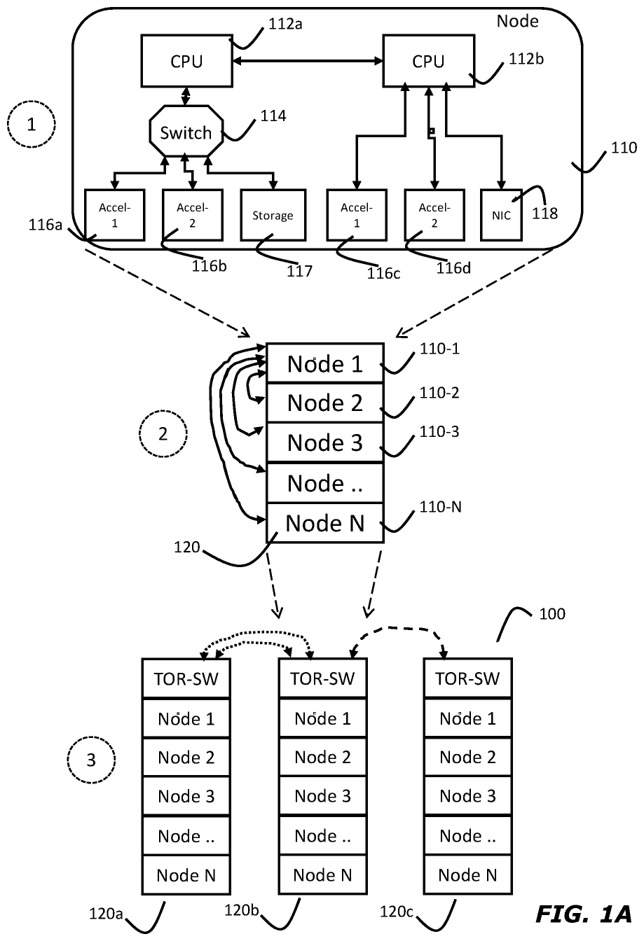

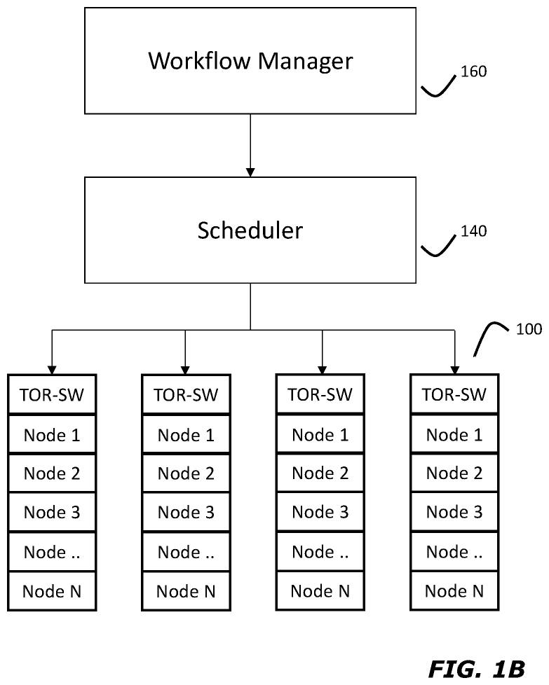

FIG. 1A illustrates the components of an example computer system 100 such as a cloud service. The system is drawn to show the hierarchy of elements. For example a node 110 includes a number of components 112, 114, 116. A computing cluster 120 (e.g., rack) includes a number of nodes 110 and the computer system 100 includes a number of computing clusters 120. The particular elements shown are provided as examples to illustrate the energy optimization schemes discussed herein and are illustrative only.

In the example of FIG. 1A, the node 110 is a compute node such as a server. While not shown, the node 110 could also be a storage node or a communication module. The server can be a computing system or device that provides services, such as data storage or processing capabilities, to other computing systems or devices (clients) over a network. The server can include various types of processors 112a and 112b (collectively 112) and accelerators 116a, 116b, 116c, 116d (collectively 116) and may be part of a larger interconnected system such as a cloud service. The server 110 may also be a node in a computing cluster 120 and can be involved in executing tasks or jobs as part of a workload.

The server 110 includes central processing units (CPU) 112a and 112b. The CPUs 112 can be hardware components within the computer system that execute instructions of a computer program. These instructions are typically part of a software application or operating system that is running on the computer system. The CPUs 112 perform a variety of operations as specified by these instructions including basic arithmetic operations, logical operations involving making decisions based on logical conditions, control operations involving controlling the flow of execution in a computer program, and input/output (I/O) operations involving interacting with the computer system's input and output devices.

In the illustrated examples, the CPUs 112 control other components 116, 117, 118, in some cases directly and in other cases through a switch 114. These components can include hardware accelerators 116. The accelerators 116 can be specialized hardware units designed to perform specific computational tasks more efficiently than general-purpose CPUs 112. For example, the hardware accelerators can be devices such as graphics processing units (GPUs), field-programmable gate arrays (FPGAs), or other custom silicon devices that are used to accelerate execution of specific workloads in the computing system.

The compute node 110 also includes a storage device 117, e.g., smart storage device, and a communication device 118, e.g., a network interface card (NIC). The smart storage device 117 is responsible for storing data. For example, a smart storage device can include a storage unit that is capable of performing additional operations beyond simple data storage. These operations may include data processing, data analysis, and data movement tasks. The smart storage device may also have the ability to communicate with other components of the system, such as processors and accelerators.

The communication device 118 enables network communication. For example, a NIC 118 can provide a physical connection to a network, convert data into a format that can be transmitted over the network, and send and receive data packets. The communication device 118 can play a role in data movement and communication between different components of the computing system, for example to communicate with other nodes 110 within a computing cluster 120 or between clusters 120 in the system 100.

As also shown in FIG. 1A, the node 110 may be part of the computing node cluster 120, such as a rack. In this example, the computing node cluster 2 includes a group of interconnected computing nodes 110-1 to 110-N, such as servers, that work together so that they can be viewed as a single system. In the illustrated example, the computing cluster 120 is a specific arrangement of nodes 110 within the larger computing system 100, such as a cloud service. The nodes within the computing cluster 120 can communicate directly with each other or via a switch (e.g., top-of-rack switch). The specific configuration and communication method within the computing cluster 120 can impact data movement and thus energy consumption as will be discussed below.

The various components of the system 100 operate to execute workloads of the cloud service. For example, the components will run the processing tasks as directed by the cloud service. As illustrated in FIG. 1B, these operations can be managed by a workflow manager 160 and scheduler 140. In managing the workflow, several concepts can be used, individually or in combination to reduce power consumptions. For example, data-movement across chips or nodes can be reduced by associating communication cost function with the directed acyclic graph (DAG) components (static dependencies of workflow manager). In some implementations, the task subsets of the workflow DAG can be packed together (e.g., for data-dependency) to minimize data movement.

The workflow manager 160 can provide workflows, each typically defined by a DAG. These DAGs allows for the definition of the applications/functions to be launched, order of launch, and relevant data buffer/pointer/storage. Examples workflow managers are Pachyderm and CUDA-Graph. The workflow manager 160 can analyze these DAGs to setup the environment for the workflow execution. The analysis done by the workflow manager 160 is usually simplistic and does not analyze the DAGs based on the hardware resources present in the computing environment.

The scheduler 140 and workflow manager 160 will be aware of the location of the compute resources (e.g., CPUs and accelerators) and their connected topology. Data movement can be minimized, or at least reduced, to help lower power consumption. For example, data movement can be quantified by system topological information and costs (e.g., bandwidth, power).

As an example, FIG. 1A illustrates three compute hierarchies, namely (1) intra-node, (2) inter-node/rack-level, and (3) inter-rack/data-center. In some aspects, the goal is to minimize data travel to perform the desired tasks. For example, a scheduling algorithm may utilize a preference of intra-chip channels over intra-node channels, intra-node-channels over intra-rack channels, and intra-rack channels over inter-rack channels.

Taking the topology into account, the scheduler 140 can be designed to consider how much energy it takes to move data around and then choose the right resource or group of resources that use less energy to run an application. For example, the scheduler 140 can look at the application's work plan, which shows the order in which different parts of the job need to communicate or share data. It then picks a way to run the job that doesn't require moving a lot of data between computers or within the same computer, which can save energy. To make sure the applications perform well, quality of service (QOS) rules are put in place and watched over. In selecting resources, the scheduler 140 can check the status of the computer(s) being used. If there are already jobs running, it might move the new job to a different machine so that everything runs smoothly without interruptions or delays.

To minimize power consumption based on data movement, the highest priority would be intra-node communications. Some compute resources such as CPUs and accelerators have different memory hierarchies (e.g., DDR, HBM, CXL) and are located inside and connected in a node by through-silicon vias (TSV) or short printed circuit board (PCB) traces. Each of these channels can be associated with a bandwidth and power cost. Inter-node/rack-level channels can be based on the copper or optical connectivity between accelerators or compute nodes. Similarly, inter-rack/data-center costs can be based on the optical connectivity. Using the cost metrics defined for data movement between compute, memory and interfaces such as bandwidth and power consumption per bit, the scheduler can determine energy optimized mapping for a workflow.

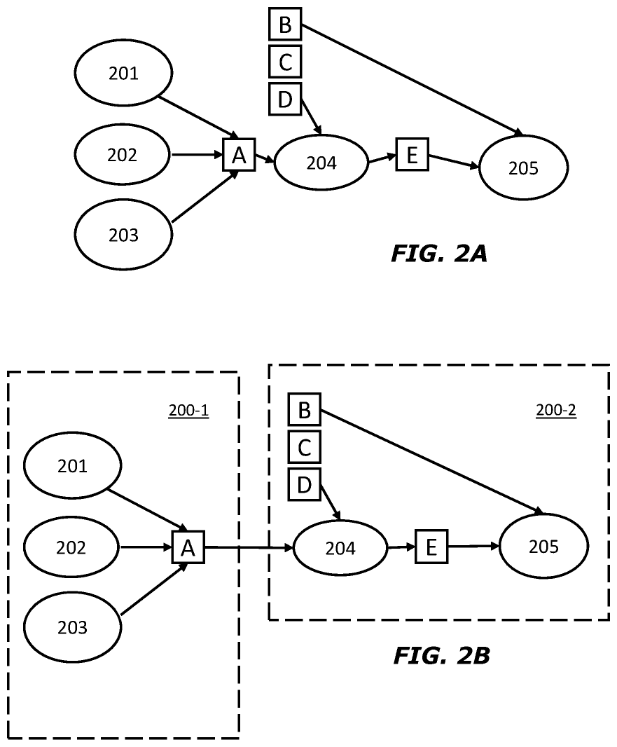

Referring to FIGS. 2A-2B, resources 201-205 may be used to execute a process using data A, B, C, D, and E. In some aspects, the scheduler checks for the resource availability, such as the availability of a specific fabric, the number of accelerators, types of accelerators, and the amount of data the workflow is processing at the instant before deploying the workload. The scheduler can dynamically compute the hardware placement of the workflow based on a cost function that reduces the data movement across chips or nodes. This may be achieved by associating a communication cost function with the DAG components, which reflect the static dependencies of the workflow manager.

The dynamic placement produced by the scheduler at the instance before launching might not be ideal when deployed in a shared infrastructure, such as in the case of serverless computing, as a target accelerator or compute node might be occupied. In such cases, the scheduler may compute the next optimum placement with the help of just-in-time (JIT) compilation and the cost function. The scheduler can uses cost metrics defined for data movement between compute, memory, and interfaces such as bandwidth and power consumption per bit to determine an energy-optimized mapping for a workflow. The cost metrics may be used by the workflow manager as a static definition of different combinations of DAG components. The cost metrics may also be used by the scheduler, dependent on the runtime of the system utilization.

The workflow manager may optimize the DAG to include components with lower power utilization and fewer data movements. For example, as shown in FIG. 2A, a workflow may involve parallel compute functions 201, 202, 203 writing in output buffer A. This output may be fed to function 204 that is reading from data buffers B, C, and D. Function 204 then produces a result in buffer E which is then used by function 205, which is also reusing data from data buffer B.

As depicted in FIG. 2B, the workflow is partitioned between resources 200-1 and 200-2. For example, resource 200-1 might be a GPU and resource 200-2 might be a CPU. The parallel functions (201, 202, 203) may run on the GPU as it provides better energy efficiency for running work in parallel. However, functions 204 and 205 may run on the CPU as it would require more time and energy to move a large amount of data (B, C, D) to the GPU if function 204 cannot achieve a high speed up with GPUs. Moreover, one of the data buffers (B) is reused across two compute functions 204 and 205. Rather than incur additional data movement that cause an increased power consumption, both function 204 and 205 can run efficiently on a single CPU 200-2.

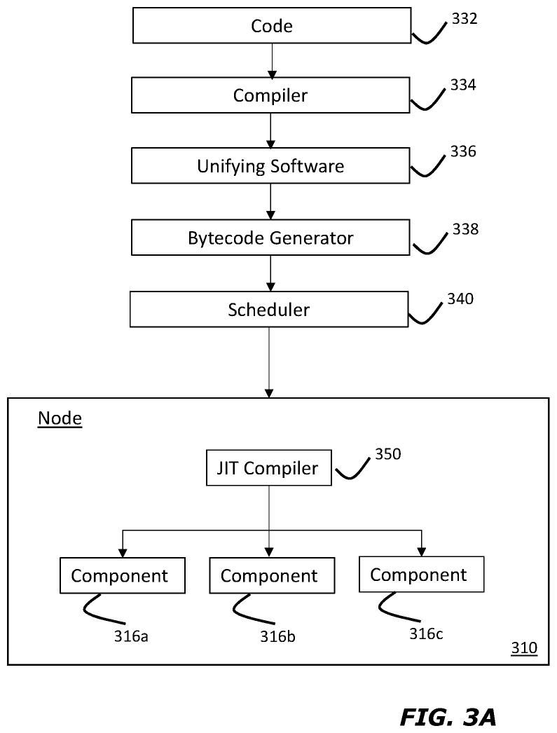

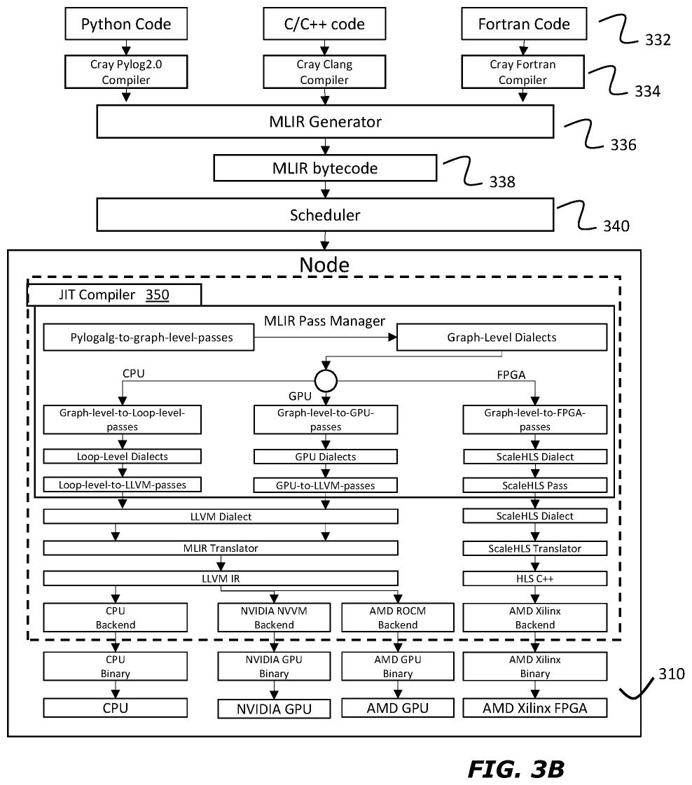

FIG. 3A provides a functional block diagram of a computing system for processing code. Source code 332 may be processed by a compiler 334. The compiler 334 translates high-level programming languages, such as Python, C/C++, or FORTRAN, into machine-readable binary code that can be executed by a computer's processor. This binary code can be provided to unifying software 336, such as an MLIR (Multi-Level Intermediate Representation) generator.

The MLIR generator 336 is a compiler component that generates bytecode 338, which is a form of low-level, machine-independent code designed to be executed by a virtual machine or interpreter. The MLIR generator operates on an intermediate representation of the source program, which is a higher-level representation that abstracts away many hardware-specific details. The generated bytecode 338 is designed to be portable across different hardware architectures, as it is executed by a virtual machine or interpreter that provides an abstraction layer over the underlying hardware. This allows the same bytecode to run on various platforms, as long as a compatible virtual machine or interpreter is available. For example, in some implementations, the compiled code is provided to an intermediate representation generator, which provides an output to a bytecode generation module.

The bytecode can then be provided to scheduler 340. As noted above, the scheduler 340 is responsible for efficiently allocating and managing computing resources across multiple users and applications. It acts as a central orchestrator, distributing workloads and tasks across a pool of virtual machines, containers, or physical servers based on predefined policies and resource availability. The scheduler 340 typically employs sophisticated algorithms and heuristics to optimize resource utilization, load balancing, and performance while adhering to constraints such as resource quotas, affinity rules, and service-level agreements (SLAs).

Some examples of the algorithms and heuristics that the scheduler 340 might employ are provided here. The examples are intended to describe certain implementations. It is understood that these examples might be used in combination and other methodologies can be employed.

One example of an algorithm used by the scheduler 340 is a bin packing algorithm. In this case, the scheduler 340 treats available resources (e.g., servers, virtual machines) as bins and tasks as items to be packed into the bins. It aims to minimize the number of bins (resources) used while ensuring that tasks are efficiently packed without exceeding resource capacities. For example, the scheduler 340 might use a best fit decreasing algorithm, where tasks are sorted in decreasing order of their resource requirements and placed in the most suitable resource that can accommodate them.

As another example, a load balancing heuristic can be used where the scheduler 340 can monitor the load on each resource and dynamically distribute tasks to maintain a balanced workload across the system. It might consider factors such as CPU utilization, memory usage, network bandwidth, resource location, channels between resources, and I/O operations to determine the load on each resource. For example, the scheduler 340 can employ a weighted round-robin algorithm, assigning tasks to resources based on their current load and capacity, giving higher priority to resources with lower utilization to achieve a more even distribution of workload while considering data movement.

If using an affinity rule heuristic, the scheduler 340 can take into account affinity rules that specify preferences or constraints for task placement. Affinity rules can include requirements such as placing tasks on the same host, spreading tasks across different racks or data centers, or ensuring that certain tasks are not co-located, as well can attempting to minimize power expended for data movement. For example, the scheduler 340 can use a graph-based algorithm to represent tasks and their affinity relationships. It could then apply graph coloring techniques to assign tasks to resources while satisfying the affinity constraints.

In another example, an SLA-aware scheduling algorithm can be implemented where the scheduler 340 considers SLAs that define performance targets and priorities for different tasks or user groups. It prioritizes the execution of tasks based on their SLA requirements, such as response time, throughput, or availability. For example, the scheduler 340 can employ a priority queue and a preemptive scheduling algorithm. Tasks with higher SLA priorities are placed at the front of the queue and can preempt lower-priority tasks if necessary to meet their SLA targets.

As yet another example, the scheduler 340 can implement reinforcement learning-based scheduling. The scheduler 340 utilizes reinforcement learning techniques to learn from past scheduling decisions and optimize future decisions. It trains a model based on historical data, considering factors like resource utilization, task performance, data movement, and SLA compliance. For example, the scheduler 340 can employ a Q-learning algorithm, where it learns to make scheduling decisions based on the current state of the system and the expected long-term rewards. It continuously updates its decision-making model based on the observed outcomes.

As a final example, the scheduler 340 can implement constraint optimization algorithms where the scheduling problem is formulated as a constraint optimization problem, considering various constraints such as resource capacities, task dependencies, data location, and time windows. The scheduler 340 uses optimization algorithms like integer linear programming (ILP) or constraint programming (CP) to find optimal or near-optimal scheduling solutions. For example, the scheduler 340 can use an ILP solver to determine the optimal assignment of tasks to resources, minimizing overall resource usage while satisfying all the defined constraints.

These are just a few examples of the algorithms and heuristics that a cloud scheduler might employ. The specific algorithms and heuristics used can vary depending on the characteristics of the workload, the available resources, and the optimization objectives of the cloud system.

As discussed herein, the scheduler 340 can determine resources available to execute a job and determine a location and connected topology of the resources. For each of a combination of the available resources, bandwidth information related to channels to move data to the resources to execute the job is determined. The bandwidth information considers the location of data to be used to execute the job and the channels between the resources. The job can then be assigned to a resource or a combination of resources using a scheduling algorithm that takes into account the bandwidth information and power considerations.

One example of a scheduling algorithm that consider bandwidth information and power considerations when assigning jobs to is bandwidth-aware scheduling algorithm. In this example, the scheduling function considers the job to be scheduled, the available resources, and a bandwidth matrix representing the available bandwidth between resources. The algorithm sorts the resources based on their maximum available bandwidth to other resources. It then assigns the job to the resource with the highest available bandwidth. After the assignment, the bandwidth matrix is updated to reflect the reduced available bandwidth due to the job's bandwidth requirements.

Another example is a power-aware scheduling algorithm, where scheduling function considers the job to be scheduled, the available resources, and a dictionary representing the power consumption of each resource and data paths between the resources. The algorithm sorts the resources based on their power consumption in ascending order. It then assigns the job to the resource with the lowest power consumption. After the assignment, the power consumption of the selected resource is updated to reflect the additional power required by the job.

These two examples are simplified examples to illustrate the concept. In practice, the scheduling algorithm may need to consider additional factors such as resource capacities, job dependencies, and other constraints. The algorithm can also be extended to handle scenarios where a combination of resources is required to execute a job. In the implementation shown in FIG. 3A, the scheduler 340 assigns a workload to node 310, which is an example of one of many nodes available to the scheduler. One specific example is shown in FIG. 3B, discussed below. This node 310 includes a just-in-time (JIT) compiler 350 that may optimize the execution of the bytecode at runtime within the computational node 310. The JIT compiler can be implemented as a component of the runtime environment that improves the performance of applications by compiling bytecodes to native machine code at run time. While useful for both CPUs and GPUs, this optimization may result in better application-level performance with a CPU than a GPU due to multiple factors associated with GPUs, such as data transfer overheads, task launching overheads, and parallelization granularity. Just-in-time (JIT) compilation can also be used to dynamically map task subsets, e.g., to dynamically adjust scheduler decisions. This allows close to real-time decision making to further optimize scheduling.

In some aspects, with run-time utilization information from all the nodes, the scheduler 340 may use the cost metrics information for data movement, execution time, different DAG options provided by a workflow manager, and JIT compilation times for newer hardware configurations to calculate a cost function. This cost function may be represented as

ƒ(α(cos[t]_bw+cos tnpower), δ(cos tmexec_time), ⊆(DAGs), Δ(TimeJIT)),

where n represents different types of interconnectivity between compute nodes, m represents different types of compute elements or devices in the cluster or clusters, α represents run-time utilization of the interconnect during a specific time frame, δ represents run-time utilization of the compute device, ⊆ represents the selection of an optimum DAG per cluster availability, and A represents the time for JIT compilation for different compute devices versus precompiled binaries.

Even if JIT is not available, the other cost parameters can provide an appropriate scheduler cost value. This approach may contribute to energy savings in computing environments by optimizing data movement.

Code compiled by JIT compiler 350 can be executed by the components 316, which may be CPUs, GPUs, or other accelerators. The program instructions, when executed by one or more processors, may cause the processors to transfer bytecode to the assigned resource and compile the bytecode at the resource using the just-in-time compiler.

FIG. 3B illustrates a specific example implementation of the JIT compiler framework depicted in FIG. 3A. This example is provided only to illustrate a single practical application of the system being discussed herein. It is understood that this particular example is not limiting.

In some aspects, a heterogeneous application may be written in a high-level language such as C++ or FORTRAN with OpenMP pragmas, or OpenCL, or HIP. However, choosing which device to offload a task to may require prior knowledge of the task's traits as well as the available hardware at compile time. Different compiler front-ends, such as compilers 334, may be used to generate device-independent MLIR bytecode 338. This bytecode 338 may then be passed to the scheduler 340. The scheduler 340 may then decide which node, such as computational node 310, to offload the task. The MLIR bytecode 338 may be transferred to that node to be compiled to the requisite binary using a just-in-time compiler 350.

The scheduler 340 may make decisions based on a variety of factors, including the traits of the task, the available hardware, and the size of the bytecode 338. The size of the bytecode 338 may be smaller than the size of the compiled binary. This size difference may assist in data transfer optimization.

The factors considered by the scheduler 340 while utilizing bytecodes 338 for just-in-time (JIT) compiling at the resources can include factors such as task characteristics, available hardware, bytecode characteristics, and resource utilization and load balancing, as examples. Specific implementations may consider some or all (or none) of these factors, perhaps in combination with other factors.

Task characteristics can include complexity, memory requirements, parallelism, and dependencies, as examples. For example, the scheduler 340 assesses the computational complexity of the task considering that tasks with higher complexity may require more resources and longer execution times. The scheduler 340 may prioritize these higher complexity tasks or allocate them to more powerful resources. The memory footprint of the task can also considered where tasks with large memory requirements may need to be scheduled on resources with sufficient memory capacity to avoid performance bottlenecks.

The scheduler 340 can also evaluate the potential for parallelism within the task. Tasks that can be parallelized effectively may be assigned to resources with multiple cores or distributed across multiple resources to improve execution speed. If the task has dependencies on other tasks or data, the scheduler 340 analyzes the dependency graph. It may prioritize tasks that have their dependencies satisfied to minimize data movement, avoid resource idling, and optimize overall workflow execution.

The scheduler 340 will also evaluate available hardware. For example, the scheduler 340 can consider the CPU architecture of the available resources and match the task's requirements with the appropriate CPU instruction set and capabilities to ensure optimal performance. The number of CPU cores and threads available on each resource can also be taken into account. The scheduler 340 may assign tasks to resources with sufficient cores or threads to leverage parallelism and improve execution efficiency.

The scheduler 340 can also consider the memory hierarchy of the resources, including cache sizes, memory bandwidth, memory location, and latency. It may optimize task placement to maximize cache utilization and minimize memory access bottlenecks.

If the resources have specialized hardware accelerators (e.g., GPUs, FPGAs), the scheduler 340 may evaluate the task's suitability for acceleration. Tasks that can benefit from hardware acceleration may be assigned to resources with the appropriate accelerators.

The scheduler 340 might also consider bytecode characteristics, such as the size of the bytecode. Larger bytecodes may require more memory and take longer to compile and load. The scheduler 340 may consider the available memory on the resources and the compilation overhead when making scheduling decisions. The scheduler 340 may estimate the JIT compilation time based on historical data or heuristics in an attempt to minimize the compilation overhead and optimize the overall execution time.

The scheduler 340 can also analyze the bytecode to assess its optimization potential. It looks for opportunities to apply JIT optimizations, such as inlining, loop unrolling, or constant folding. Tasks with higher optimization potential may be prioritized for JIT compilation. The scheduler 340 may also consider the expected runtime behavior of the bytecode, e.g., by analyzing factors such as the presence of hot spots, frequently executed code paths, or the likelihood of code reuse. This information helps the scheduler 340 make decisions about JIT compilation thresholds and optimization strategies.

The scheduler 340 can also consider current resource utilization, load balancing, and locality. For example, the scheduler 340 can monitors the current utilization of the available resources taking into consideration factors such as CPU usage, memory consumption, and I/O activity in an attempt to distribute tasks evenly across resources to prevent overloading and ensure optimal resource utilization. The scheduler 340 can also employs load balancing techniques to distribute tasks across resources by considering the current workload on each resource to assign tasks to resources with lower utilization to maintain a balanced system.

As discussed herein, the scheduler 340 takes into account data locality when making scheduling decisions. The scheduler 340 can schedule tasks on resources that have fast access to the required data to minimize data transfer overheads and improve performance. By considering the channels between resources, power consumption can be lowered.

The specific algorithms and heuristics used by the scheduler 340 may vary depending on the system's requirements, workload characteristics, and optimization goals. The scheduler 340 continuously monitors the system's state and adapts its decisions based on real-time feedback and historical data to improve overall performance and resource utilization.

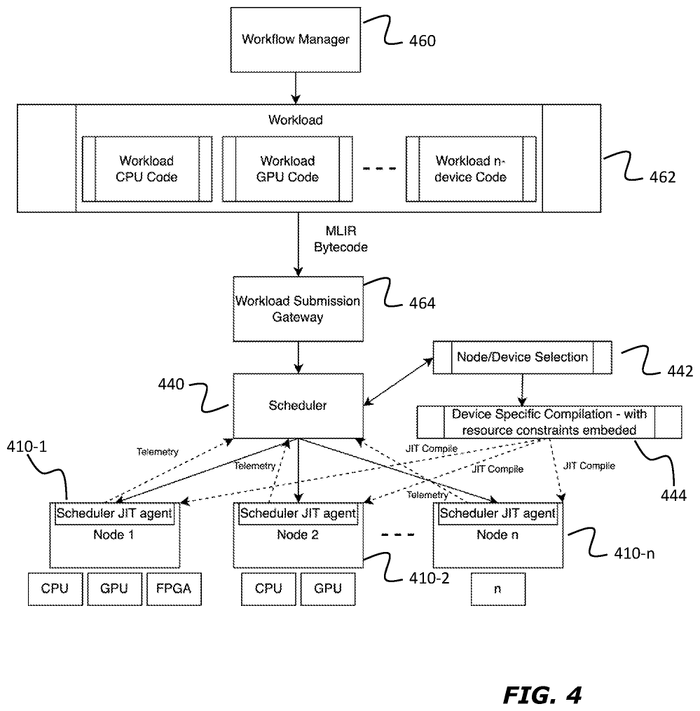

FIG. 4 provides a block diagram of a system for managing and compiling workloads across multiple nodes. The system can include a workflow management unit 460 that oversees the distribution of workload components 462. These components may include CPU code, GPU code, and potentially other device-specific code. In some aspects, these components are processed through a workload submission interface 464, which then interacts with a scheduler 440.

The scheduler 440 can be connected to a node device selection module 442. In some cases, the node device selection module 442 selects the appropriate node for workload execution based on resource constraints. The device specific compiler 444 may compile the workload for the selected node. As discussed above, the system include nodes 410, each of which includes a scheduler JIT agent. These nodes may receive the compiled workloads and execute them on the appropriate computing resources such as CPU, GPU, or FPGA.

The system can be designed to optimize the execution of workloads by selecting the optimum computing resources and compiling the workloads accordingly. The workflow manager 460 may provide a ranked list of probable hardware configurations or DAGs for each of the workloads to the scheduler 440. The workloads may come as a pre-processed version of MLIR bytecode. For example, the scheduler 440 at schedule time may decide what will be the optimum node or device to start the workload. This decision may be based on the workflow manager provided configuration, data movement requirements, energy, and location of nodes and devices if the workload requires multiple nodes or devices to complete execution.

The scheduler 440 may check for the resource availability, such as the availability of a specific fabric, the number of accelerators, types of accelerators, and the amount of data the workflow is processing at the instant before deploying the workload. The scheduler 440 may then dynamically compute the optimum hardware placement of the workflow based on a cost function that reduces the data movement across chips or nodes. This may be achieved by associating a communication cost function with the DAG components, which reflect the static dependencies of the workflow manager.

In some aspects, the scheduler 440 may compute the next optimum placement with the help of JIT compilation and the cost function if the target accelerator or compute node might be occupied. The cost metrics may be used by the workflow manager 460 as a static definition of different combinations of DAG components. The cost metrics may also be used by the scheduler 440, dependent on the runtime of the system utilization. In other cases, the workflow manager 460 may optimize the DAG to include components with lower power utilization and fewer data movements.

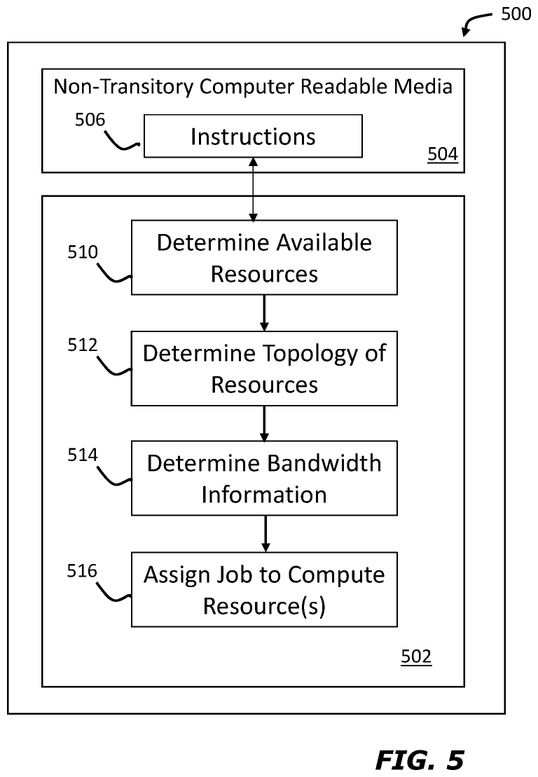

FIG. 5 illustrates an implementation example of a computer device 500, such as a scheduler. The computer device 500 includes one or more processors 502 and non-transitory computer readable storage media 504 storing instructions 506 that, when executed by the processor(s) 502, cause the processor(s) to perform a computer-implemented method. In this implementation, the processor(s) determine resources available to execute a job (operation 510), determine a location and connected topology of the resources (operation 512), and, for each of a combination of the available resources, determine bandwidth information related to channels to move data to the resources to execute the job (operation 514). The bandwidth information considers the location of data to be used to execute the job and the channels between the resources. The scheduler can then assign the job to a resource or a combination of resources using a scheduling algorithm that takes into account the bandwidth information and power considerations (operation 516).

In an example implementation, the channels between resources include intra-chip channels, intra-node channels, intra-rack channels, and inter-rack channels and the scheduling algorithm utilizing a preference of intra-chip channels over intra-node channels, intra-node-channels over intra-rack channels, and intra-rack channels over inter-rack channels.

In another example implementation, the program instructions, when determining the available resources, cause the processor(s) to determine types of processors and accelerators that are available, a number of processors and accelerators that are available, and an amount of data to be processed.

In another example implementation, the program instructions, when assigning the job, cause the processor(s) to dynamically compute a hardware placement of the workflow based on a cost function that uses cost metrics for data movement between compute, memory and interfaces.

In another example implementation, the program instructions cause the processor(s) to transfer bytecode to the assigned resource and compile the bytecode at the resource using a just-in-time compiler.

The foregoing outlines features of several examples so that those skilled in the art may better understand the aspects of the present disclosure. Various modifications and combinations of the illustrative examples, as well as other examples, will be apparent to persons skilled in the art upon reference to the description. It is therefore intended that the appended claims encompass any such modifications.

What is claimed is:

1. A computer-implemented method comprising:
determining resources available to execute a job;
determining a location of each resource and a connected topology of the resources;
for each of a combination of the available resources, determining bandwidth information related to channels to move data to the resources to execute the job, the bandwidth information considering the location of data to be used to execute the job and the type of channels between the resources; and
assigning the job to a resource or a combination of resources using a scheduling algorithm that takes into account the bandwidth information and power considerations.

2. The method of claim 1, wherein the channels between resources include intra-chip channels, intra-node channels, intra-rack channels, and inter-rack channels, the scheduling algorithm utilizing a preference of intra-chip channels over intra-node channels, intra-node-channels over intra-rack channels, and intra-rack channels over inter-rack channels.

3. The method of claim 1, wherein determining the available resources comprises determining types of processors and accelerators that are available, a number of processors and accelerators that are available, and an amount of data to be processed.

4. The method of claim 1, wherein assigning the job comprises dynamically computing a hardware placement of a workflow based on a cost function that uses cost metrics for data movement between compute, memory and interfaces.

5. The method of claim 4, performing just-in-time execution of the job using resources determined by the hardware placement of the workflow.

6. The method of claim 1, further comprising:
transferring bytecode to the assigned resource or combination of resources; and
compiling the bytecode at the resource or combination of resources using a just-in-time compiler.

7. The method of claim 1, wherein the scheduling algorithm also takes into account computation time, quality of service, and service-level agreements.

8. A device comprising:
one or more processors; and
a storage device storing program instructions that, when executed by the one or more processors, cause the one or more processor to:
determine resources available to execute a job;
determine a location of each resource and a connected topology of the resources;
for each of a combination of the available resources, determine bandwidth information related to channels to move data to the resources to execute the job, the bandwidth information considering the location of data to be used to execute the job and the type of channels between the resources; and
assign the job to a resource or a combination of resources using a scheduling algorithm that takes into account the bandwidth information and power considerations.

9. The device of claim 8, wherein the channels between resources include intra-chip channels, intra-node channels, intra-rack channels, and inter-rack channels, the scheduling algorithm utilizing a preference of intra-chip channels over intra-node channels, intra-node-channels over intra-rack channels, and intra-rack channels over inter-rack channels.

10. The device of claim 8, wherein the program instructions, when determining the available resources, cause the one or more processors to determine types of processors and accelerators that are available, a number of processors and accelerators that are available, and an amount of data to be processed.

11. The device of claim 8, wherein the program instructions, when assigning the job, cause the one or more processors to dynamically compute a hardware placement of a workflow based on a cost function that uses cost metrics for data movement between compute, memory and interfaces.

12. The device of claim 8, wherein the program instructions cause the one or more processors to:
transfer bytecode to the assigned resource or combination of resources; and
compile the bytecode at the resource or combination of resources using a just-in-time compiler.

13. The device of claim 8, wherein the scheduling algorithm also takes into account computation time, quality of service, and service-level agreements.

14. A system comprising:
a workflow manager;
a scheduler coupled to the workflow manager; and
a plurality of nodes coupled to the scheduler;
wherein the workflow manager is configured to provide bytecodes to the scheduler, each bytecodes providing instructions for executing an associated workload;
wherein the scheduler is configured to schedule the workloads based on power considerations including bandwidth information related to channels to move data to resources of the nodes to execute the workloads, the bandwidth information considering locations of data to be used to execute the workloads and channels between the resources of the nodes; and
wherein each nodes is configured to receive a workload assignment including associated bytecodes from the scheduler, to compile the workload from the bytecodes, and execute the workload.

15. The system of claim 14, wherein the scheduler is configured to schedule the workloads by determining resources available to execute each workload, determining a location of each resource and a connected topology of the resources, determining the bandwidth information for each of a combination of the available resources, and assigning each workload to a resource or a combination of resources based on the power considerations.

16. The system of claim 15, wherein determining the available resources comprises determining types of processors and accelerators that are available, a number of processors and accelerators that are available, and an amount of data to be processed.

17. The system of claim 15, wherein assigning each workload comprises dynamically computing a hardware placement of a workflow based on a cost function that uses cost metrics for data movement between compute nodes, memory and interfaces.

18. The system of claim 14, wherein the channels between the resources include intra-chip channels, intra-node channels, intra-rack channels, and inter-rack channels, and wherein the scheduler is configured to schedule the workloads using a scheduling algorithm that utilizes a preference of intra-chip channels over intra-node channels, intra-node-channels over intra-rack channels, and intra-rack channels over inter-rack channels.

19. The system of claim 14, wherein the resources include central processing units, graphic processing units, storage devices, and communications devices.

20. The system of claim 14, wherein the scheduler is configured to schedule the workloads based on the power considerations, computation times, quality of service, and service-level agreements.
